(19) United States
(12) Patent Application Publication
(10) Pub. No.: US 2006/0206350 A1
(43) Pub. Date: Sep. 14, 2006

(54) Security method and apparatus for preventing credit card fraud

(76) Inventors: Michael Edwards, Malaga (ES); Steven Kent Russell, Malaga (ES); Gary Owen Lweis, Gateshead (GB)

Correspondence Address: CALFEE HALTER & GRISWOLD, LLP, 800 SUPERIOR AVENUE, SUITE 1400, CLEVELAND, OH, 44114, US

(21) Appl. No.: 11/288,452

(22) Filed: Nov. 23, 2005

Related U.S. Application Data
(63) Continuation-in-part of application No. PCT/GB04/02109, filed on May 24, 2003.

(30) Foreign Application Priority Data
May 24, 2003 (GB) 0312038.3

(51) Int. Cl. G06Q 99/00

(52) U.S. Cl. 705/1

(57) ABSTRACT

A security method comprises inputting into a database on a computer system (2) data as to a forecast of transfer relative to the database, and inputting into the database data as to actual transfers relative to the database, the computer system taking appropriate action in the event that the transfers are not in accordance with the forecast. Apparatus for performing the security method comprises a computer system (2) comprising a database and being arranged to receive data as to the forecast of transfer relative to the database and as to the actual transfers relative to the database and to take the appropriate action in the event that the actual transfers are not in accordance with the forecast. The security method also comprises up-dating specific fields of transfer, personal security alerts, pre-authorisations of transfers and personal identification.

### RELATED APPLICATIONS

This application is a continuation-in-part of International Application No. PCT/GB2004/002109 filed on May 21, 2004 which claims priority to GB application No. 0312038.3 filed on May 24, 2003. This application claims priority to, and claims the benefit of, the filing date of said International Application and said GB application. This application also claims priority to and claims the benefit of UK application No. 05 199 27.8, filed Sep. 30, 2005. The disclosures of said applications are hereby incorporated by reference in their entirety.

### METHOD AND APPARATUS

This invention relates to a security method and apparatus for use in such method and in particular to preventing financial card fraud.

A system for preventing credit card fraud is known whereby a user of the system adds a personal password for each card he or she owns. Intended for Internet shopping only, those online merchants who use the system require the user to enter the password at the payment stage. Another known system is applicable to many industry sectors and uses complex heuristics and statistical analysis to define a “typical” usage pattern for card users as a means to defeat fraud. Thus, should a card user purchase exceed what is statistically normal, the transaction may be denied.

A further known system uses a microchip embedded into a card for reducing fraud in point-of-sale (customer present with card) transactions. Instead of using a signature to verify payments, the customer is asked to enter a four-digit PIN (Personal Identification Number) known only to the customer. The microchip embedded into the card records transactions and provides upgrade paths for future uses, for example, customer purchasing preferences and frequency of transactions, which can be downloaded by card issuers, with or without the card holder's permission, for trend analysis.

According to a first aspect of the present invention, there is provided a security method comprising inputting into a database on a computer system data as to a forecast of transfer relative to said database, and inputting into said database data as to actual transfers relative to said database, said computer system taking appropriate action in the event that said transfers are not in accordance with said forecast.

According to a second aspect of the present invention there is provided apparatus comprising a computer system for managing security, said system comprising a database and being arranged to receive data as to a forecast of transfer relative to said database and as to actual transfers relative to said database and to take appropriate action in the event that said actual transfers are not in accordance with said forecast.

Owing to these two aspects of the invention, it is possible to provide security, particular, but not exclusively, to reduce financial fraud, in a relatively simple and cost-effective manner.

In a preferred embodiment, the security method comprises inputting into the database a forecast by the card holder of use of a financial card, such as a debit or credit card, the computer checking against the forecast the transactions carried out with the card. Advantageously, if use of the card does not match the forecast in the database, a warning would be issued either to a vendor performing a transaction with that card not to accept it or directly to the card holder via, for instance, a mobile telephone to verify the transaction.

Thus, a card holder is able to notify the card Company of intended purchases in advance to a centre, such as a call centre (for those who do not have access to a computer) or web site, having access to the database. The computer would then check spending against the previously forecasted amount(s).

According to a third aspect of the present invention, there is provided a security method comprising a user inputting into a database on a computer system data as to a forecast of transfer relative to a predefined specific field of transfer of said database, and said user up-dating the forecasted transfer in relation to said specific field of transfer.

Owing to this aspect of the present invention, it is possible for a user of the database to forecast financial transfers and up-date the forecasts to suit the user's lifestyle.

Preferably, the security method comprises inputting into the database a forecast by the user who is a holder of a financial card and the specific field of transfer can be a wide variety of fields incorporated in the database and which may relate, for example, to trade sectors, such as the use of automatic transaction machines (ATMs), or relate to type of retailer, i.e. a vegetarian would usually never use their financial card in a butcher's shop, it can relate to geographical location, and can also relate to a particular time of day such that a forecasted transfer can be set to occur at a particular time which suits the lifestyle of the user.

According to a fourth aspect of the present invention, there is provided a security method comprising performing a financial transaction, transmitting a signal as part of said transaction, and receiving said signal as a security alert.

Owing to this aspect of the present invention, it is possible for a person performing a financial transaction to transmit a signal to a party outside of the transaction which is received by that party as an alert to indicate that the person performing the transaction believes that their personal security is in danger.

According to a fifth aspect of the present invention, there is provided a security method comprising inputting into a database on a computer system data as to a pre-authorisation of transfer relative to said database before said transfer takes place, and inputting into said database data as to an actual transfer which is said pre-authorised transfer.

Owing to this aspect of the present invention, an actual transfer relative to the database is always pre-authorised to reduce denial fraud.

In a preferred embodiment, the pre-authorisation is given by a financial card holder which pre-authorises uses of the financial card, such pre-authorisation preventing the card holder denying the occurrence of a pre-authorised transfer using that financial card.

According to a sixth aspect of the present invention, there is provided a personal identification method comprising inputting into a database on a computer system identification image data of an individual, said individual allowing access to said database by an authorised other for verification of the identity of said individual.

Owing to this aspect of the present invention, it is possible for an individual to grant access to the individual's database to another party to whom the individual wishes to prove his identity.

Preferably, the identification image data comprises scanned colour images of physical identity documents belonging to the individual. Thus, the individual and the authorised other party would be able to securely transact without any physical identification documents of the individual. In a preferred embodiment, the database of the identification document images is incorporated into a secure financial database, such that secure payment as part of the transaction can also be made, if required.

In order that the present invention can be clearly and completely disclosed, reference will now be made, by way of example, to the accompanying drawings, in which:

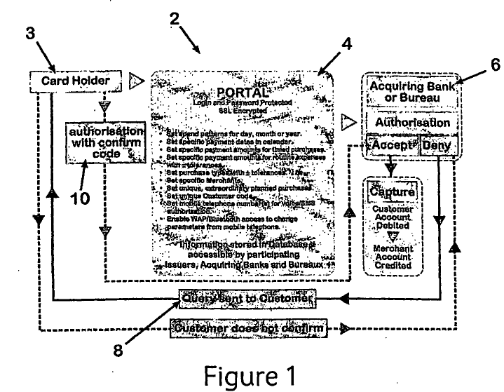

FIG. 1 shows a flow diagram of an anti-fraud system for preventing debit or credit card fraud,

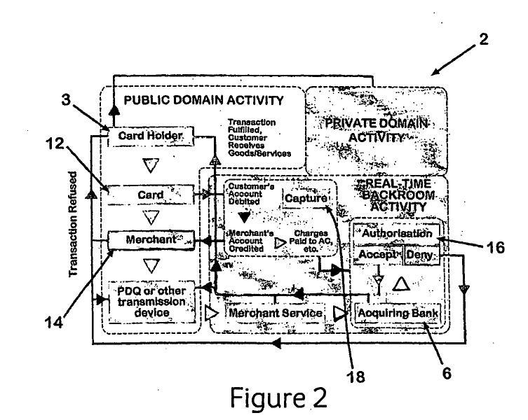

FIG. 2 shows a flow diagram of a customer-present-with-card transaction using the anti-fraud system of FIG. 2,

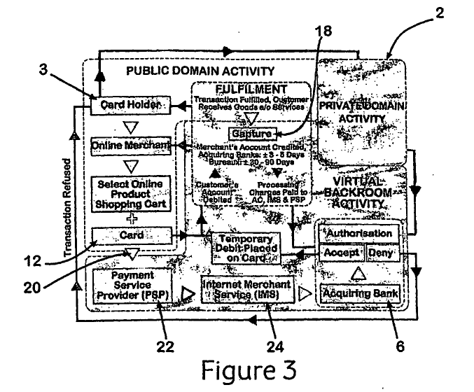

FIG. 3 shows a flow diagram of a card-not-present transaction using the anti-fraud system of FIG. 1,

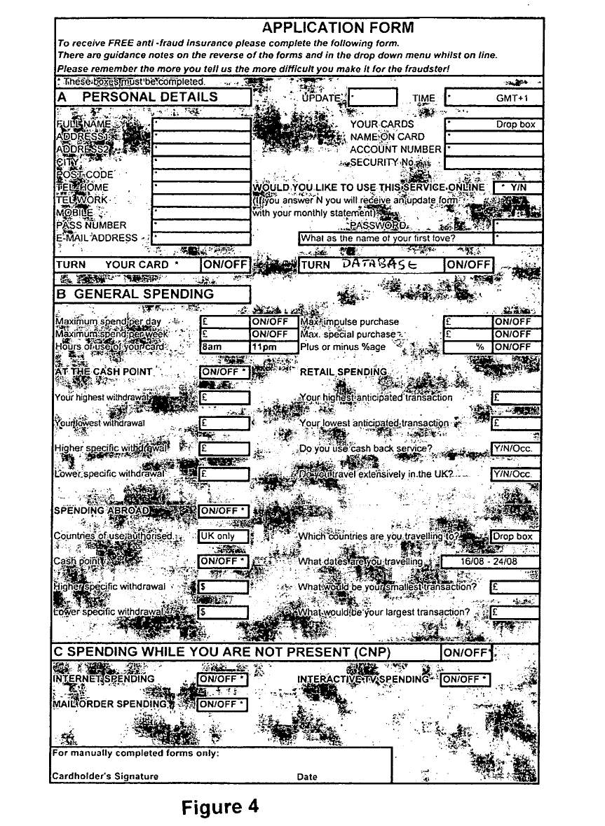

FIG. 4 shows an application form for applying to a security system for preventing financial card fraud, and

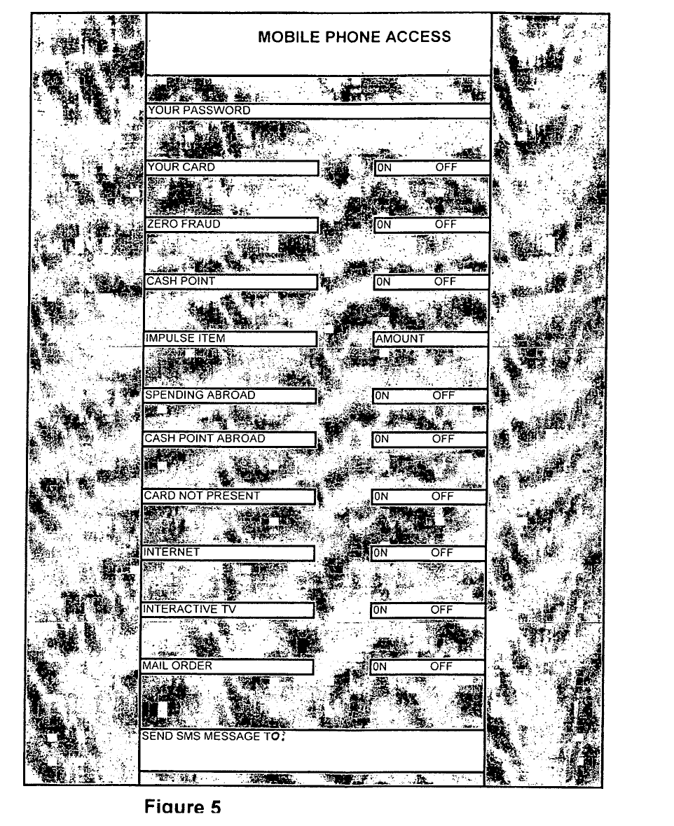

FIG. 5 shows a second form which can accompany the form of FIG. 4.

Referring to FIG. 1, an anti-fraud system 2 for preventing debit or credit card fraud brings a card holder 3 into the financial transaction loop as a pro-active participant in defining and determining his own spend decisions by setting his own spending patterns and limits for transactions whilst at the same time preventing the fraudulent use of his personal payment instrument i.e. a debit or credit card. The card holder 3 simply enters, via the Internet or a call centre, a completely secure global portal 4 to access his financial database. The card holder could have one or more secret pass-codes, which would allow access to the database, either by allowing access to the website or by confirming identity of the holder to the call centre. If entry into the portal 4 is through the Internet, the transmission of the pass-code(s) is in an encrypted form, for example by Secure Sockets Layer (SSL) encryption or by Secure Electronic/Encryption Transaction (SET).

The card holder 3 then follows a simple set of instructions to forecast financial transfers relative to the database, by identifying and setting spend allowances for such things as routine, recurring living expenses, for example petrol, food and sundries, medications, clothing, timed payments for larger purchases, insurance payments, school fees, subscriptions to cable and satellite services or magazines and newspapers, and entertainment.

For flexibility, the card holder could name retailers as far in advance as wanted and the forecast amounts could have a plus and/or minus parameter set on them to avoid refusal of a reasonable impulse purchase, whilst, at the same time, protecting against a fraudulent spending spree should the card be stolen. As an example, a card holder could log-on to a website, type in his relevant card details and individual pass-code(s) and authorise £100 to be spent on his card in a specific retail store, giving the transaction a + or −30% code when the forecast data is entered into the database. When the transaction is actually processed at that store a little more money is spent, say £115.22, but no warning is issued by the financial establishment processing the transaction such as an Acquiring Bank or Bureau 6 because of the +30% code.

The card holder could, for instance, forecast general amounts, for example “over the next 2 weeks I will spend £200 in petrol but each transaction will be less than £60”.

An additional level of security can be introduced by the card holder setting a further unique pass-code such that the card holder can use a mobile communications device which is equipped with suitable wireless connectivity technology, such as a palm-top computer or a mobile telephone as a completely private PIN machine to enter the necessary code.

If the card holder 3 plans on making a non-forecasted purchase, he merely enters the portal 4 using, for instance, his mobile telephone and provides the specific information for that intention. If the card holder 3 makes a spur-of-the-moment unusually large impulse purchase which, whilst within the card's credit limit, exceeds a preset tolerance, the system 2 can instantly telephone or send a text message in the form of an SMS (Short Message Service) to the mobile telephone for confirmation by choosing, for instance, the correct unique code out of, say, three codes presented.

The card holder 3 can also elect to have the system 2 send an SMS to his mobile telephone for each transaction to ask for the unique authorisation code which would virtually eliminate any fraud, or, conversely, the card holder 3 may use his mobile telephone to access his database and change limits and add further forecasted transactions on-the-spot. The system 2 operates efficiently in either card-present or card-not present transactions, and is completely extensible as new telephony technologies emerge. Thus, in order for a fraudster to succeed, they would have to have the card, the correct code(s) and, possibly, the card holder's mobile telephone, which is very unlikely.

All of the defined parameters set by the card holder 3 stored in the database is accessible by a participating card Issuer, Acquiring Bank 6 or Bureau. An instantaneous check using the system 2 and the necessary computer software confirms the accuracy of the transaction. Should there be a bona-fide purchase which does not comply with acceptable set tolerances and which constitutes an unusual transaction or is otherwise suspect, the card holder 3 receives an SMS query 8. Until the correct response 10 is sent back by the card holder in the form of the correct unique code, the transaction is suspended or denied.

The system 2 is not only useful for individual card holders, but also for Corporate bodies where several Company cards are issued to selected employees. In this instance the Company can utilise the system 2 to limit or deny specific transactions of those card-holding employees.

Referring to FIG. 2, a routine point-of-sale (POS) is shown at which both the card holder 3 and the card 12 are present. A merchant 14 has arranged Merchant Services and has been given a unique identification code to identify itself through its Acquiring Bank 6, which in many cases is its regular bank. If the merchant 14 does not have sufficient volume of card sales to justify the initial setup fees and recurring transaction charges, it may use a paper voucher for imprinting or a voice call-in service, but these methods are increasingly rare.

The card holder 3 arrives at the checkout point and presents his card 12 as the method of payment. The card 12 is “swiped” in a card reader, conventionally known as a PDQ machine, and the card details are collected. The purchase amount is entered and all information is then transmitted over standard telephone, ISDN or ADSL lines to the Acquiring Bank 6 for authorisation 16. The Acquiring Bank 6 confirms the authenticity of the card details, routinely checks that number against a list of lost or stolen cards, checks the database via the portal 4 of the system 2 and confirms that the purchase is within the credit limit of the card holder's account. Upon acceptance, the card holder 3 signs a paper slip printed out by the PDQ or types in a security code instead of a signature if the card is one with an embedded microchip, and is given a paper copy, proving purchase. In the event of the card holder's credit limit being exceeded, or there is suspicion of fraud, authorisation 16 is denied, a denial message being transmitted back to the merchant 14, and the transaction may be refused. Simultaneously or alternatively, as already mentioned above, a message can be sent directly to the card holder to confirm or deny the transaction himself.

If successful, the transaction is then considered fulfilled and capture 18 occurs, and the card holder's account is simultaneously debited as the card holder's account is credited. Without the customer being aware, the merchant 14 is charged a processing fee and/or a percentage of the transaction amount (1.5-7.0%) for the service provided by the Acquiring Bank 6 and its merchant services, which is deducted from the merchant's account.

Transactions for which the card holder 3 and hence the card 12 are not present occur in various ways, the two most important being telephone sales and Internet sales.

If an “offline” transaction, the customer has a verbal telephone communication with a telesales person or purveyor and places an order with that person for goods and/or services. The telesales organisation may have a PDQ present, the telesales person manually entering the card number and the purchase amount and who then waits for authorisation from their Bureau or Acquiring Bank 6, whilst the customer is still on the telephone. This process is very much like a POS transaction discussed above.

Contrary to the popular perception of most consumers, who are comforted by the security of a trustworthy human voice on the other end of the telephone line, this form of transaction has a much higher incidence of fraud. One study has shown an offline merchant could lose, as a result of fraud, £25 per £1,000 (2.5%) of telephone transactions versus £1 per £1,000 (0.1%) using a secure online website. If a confidential PIN or password is added to the offline process, there is a risk for serious fraud to occur. This would impact not only the customer whose details are harvested by an unscrupulous telesales person, but much more so for the offline merchant who in good faith may have fulfilled an order with fraudulently gained confidential information.

Experiencing astronomical growth year-on-year, an online transaction using the Internet as the medium for presenting the merchant's products or services is shown in FIG. 3. In this type of transaction, the card holder 3 selects a product from the merchant's website and proceeds to a virtual checkout point 20. Having confirmed the purchase, the card holder 3 enters his card details in a form to be sent in a secure and encrypted manner. When the card holder 3 submits his card details, a chain of events transpires. The card details, merchants Account identification and purchase amount are forwarded to the merchant's Acquiring Bank 6, via a Payment Service Provider 22 and an Internet Merchant Service 24 for authorisation. A Bureau may also be used, using their own system software and banking facilities. A temporary hold for the amount of the purchase is placed on the card holder's account. Once the purchase is fulfilled, usually upon proof of shipment of the product or sometimes upon proof of receipt of the product by the card holder, capture 18 occurs and the card account is debited. However, the merchant's account is not immediately credited as in a POS transaction. If the merchant uses an Internet Merchant Service 24 and an Acquiring Bank 6, and depending upon many other factors such as the type of product sold, the amount of a typical transaction, and the creditworthiness of the merchant, the merchant's account is then credited, less charges and fees, usually within 3 to 5 days, but sometimes longer. For more risky or low volume merchants who use a Bureau, the time to crediting the merchant's account may be between 30 and 90 days.

In such a card not present transaction, as with a POS transaction, the system 2 provides complete information to the Acquiring Bank 6 or Bureau in advance, with the parameters under which the transaction should be refused and with immediate confirmation from the customer as to the authenticity of the purchase. An identified transaction using the system 2 can be processed more quickly, and therefore funds can be transferred to the merchant without the need for a chargeback which is especially advantageous for merchants who must wait 30 to 90 days if using a Bureau.

If a forecasted transaction takes place remotely over the telephone or Internet, the system 2 is such that the card holder 3 has the peace of mind that the card details given over the telephone or Internet cannot be re-used without his permission.

The credit card Company could pay to the provider of the database a small percentage of the transaction for authorisation, but in doing so would substantially reduce the incidence of card fraud. The provider of the database could also use the system 2 for assessing the credit limit of a user.

Once a holder has built up a pattern of spending over a period of time, such a pattern can be retained by the database and, if an unusual forecast were to be received detailing a spend pattern outside of the card holder's normal activities, an SMS or an e-mail could be sent requesting additional confirmation from the card holder.

If a transaction is made outside the forecast data, including any plus or minus parameters set on the forecast data, or the card is used in establishments not listed in the database, and further confirmation of the card holder is not obtainable, a warning could be issued to instruct the transaction handler not to process the transaction and any other appropriate information, for example if the card has been reported as stolen to the database, the warning would include instructions for the transaction handler to retain the card.

Such a system could be operated by issuing specially adapted cards or by using existing cards in the possession of the holder. In addition, this system could be operated with a dedicated central database for all cards issued by a wide range of card Companies, or operated by individual card Companies for their own cards. The present system has applications in all forms of transactions where a card holder's card is used, i.e. in person in a purchase transaction (POS), in any variety of card-not-present transactions, and payment of routine recurring charges. Moreover, the system is extensible and can be applied with equal efficacy to all forms of cards, e.g., credit cards, debit cards, store cards, loyalty cards, employee cards, etc.; in fact, to any form of medium consisting of an embossed unique client identification code, card verification code (CVC), a PIN (Personal Identification Number), and a magnetic swipe strip or embedded “smart” chip.

The system 2 is also such that it is not dependent on heuristics or statistical analysis for the “typical” card user, nor would there by any need for random and invasive personal checkups from card Issuers for verification of the card holder's details. There would also be no embarrassing denial of a purchase based on “abnormal” card usage. Most advantageously, it is completely private and affords freedom of choice, the only barrier being the credit limit of the card. Amounts of authorisation are accepted against the card's current available spending limit for that particular month. Future months assume that the card will have its full credit limit available, but should full settlement not occur and a shortfall in available spend versus pre-authorisation occur, the card holder would be contacted. Upon authorised transactions taking place, the database is updated against the pre-authorised table and recorded for the card holder to view via a computer, palm-top computer or mobile telephone, and which would display a card spend availability and current monthly minimum payment. A rewards scheme for using the system 2 could be developed in the form of points or the charging of lower interest rates on card balances.

Since the system 2 allows the card holder to become more involved with the whole transaction procedure, the weak link in the transaction chain that presently exists where the card holder is kept out of the “backroom” processing of the transaction as much as possible and which is exploited by opportunistic fraudsters in their criminal activities, is the very same link that the system 2 exploits for substantially lowering the occurrence of fraud.

Presently, fraudulent card transactions annually account for billions of pounds in losses to merchants, and hundreds of millions of pounds in manpower and anti-fraud systems on the part of Acquiring Banks, Bureau and all related enterprises. Moreover, the card holder is inconvenienced and unnecessarily drawn into the fraud as an innocent bystander. It is the card holder's lack of confidence in security that is holding back the potential benefits of Internet commerce. The weak link in all card transactions is the authorisation process, and the system 2 operates to eliminate that weakness, whilst adding even greater benefits to any individual or business sector that uses the system 2.

In the event that the transaction is proven to be fraudulent, the merchant is liable for the “charge-back” and its account is debited for the amount of the transaction plus a fee charged by the Acquiring Bank to process the fraud recovery. Thus, the system 2 is also of benefit to the merchant, as there is no new hardware or software to purchase or lease, nor is there any need to train employees to use the system 2. The reduction in fraud the system would create would thus result in lower fees paid to the Acquiring Bank or Bureau to cover the cost of processing fraud and, as already mentioned, it will result in quicker payment into the merchant's account. The merchant's card reading machine, if the transaction is a POS purchase, or an online message, if the transaction is of the card not present type, could identify the card holder as a user of the system 2 such that the merchant could be confident that it would not be exposed to the costs associated with chargebacks due to fraud and that there is very little chance of unauthorised purchases.

The system 2 would also be useful for the Acquiring Bank who could use the system 2 as an easy-to-access addition to its existing authorisation system, such that up-to-date and more accurate, individualised information would be available to the Acquiring Bank for each card holder. The system 2 could also be used in conjunction with embedded microchip technology to provide a complete suite of transaction and fraud elimination products. Further advantages to the Acquiring Bank would be the increased profitability by substantially reducing the need to process fraud claims and that the database would provide information to the entire retail sector as to consumer trends and purchasing decisions.

Advantages of the system 2 to card Issuers include cost savings from reduced fraudulent card use, cost savings from the point of view of research and development of other anti-fraud systems, and it renders card database hacking by a fraudster worthless.

Savings can thus be passed back to all parties in the chain of events through, for example, lower interest rates and incentive programs for the customer, lower risk and hence lower costs and improved profitability for the merchant, and lower fees and charges levied by Acquiring Banks.

The system 2 could also be utilised for payment not only made by debit or credit cards, but also by cheque or bank transfer.

Referring to FIG. 4, a cardholder becoming a member of a security system for preventing financial card fraud uses the application form shown, which can be completed on-line or be printed out and completed manually for those cardholders who do not access the system on-line. The cardholder will receive the application form monthly to correspond with the monthly statement, if any, of the or each financial card such that up-date of the database corresponds to the monthly cycles of financial card payments. Those cardholders choosing to manually complete the application form will, by their own choice, automatically receive the form monthly or will have to request the form. Optical character recognition systems could be used to scan and automatically up-date manually completed forms to the same electronic format as those completed on-line in order to allow an easy transition from manually completing to completing on-line. For those cardholders who participate in the system and take the time to fill in the application form, the anti-fraud insurance offered by the system at zero cost to the cardholder would be an incentive to participate.

The application form comprises many separate fields which correspond to the fields for a database in which the information provided on the form will be inputted. There are, initially, fields for personal details and details of the financial cards which are to be registered to the database. As is conventional, there is also a security question, the answer to which forms a password which is required for access to the database, the question in this case being “What is the name of your first love?”. The form then comprises a variety of fields relating to use of the financial card(s) to be registered.

There are fields by way of which either the use of a financial card registered to the database can be turned on or off, or the use of the actual database as a whole can be turned on or off. A cardholder may wish to control the use of individual cards if that card was, for example, temporarily misplaced, lost, stolen or left unattended and may wish to actually disable use of the whole database relatively quickly if, for example, a situation arose where the use of all cards registered to the database for that particular cardholder was to be denied. This can be conveniently achievable with on-line access through a single web page forming a template containing the financial cards registered and details of their current settings.

The form then comprises sections under the headings “B GENERAL SPENDING” and “C SPENDING WHILE YOU ARE NOT PRESENT (CNP)” relating to different fields of spending which can be completed to depict the spending pattern which suits the lifestyle of the cardholder. Thus, entering of the necessary information into the application form is, in effect, pre-authorisation by the cardholder himself to a particular financial transaction to take place in the future and, therefore, the use of such a system prevents the cardholder from denying the transaction when it takes place, such denial fraud at present being very difficult for financial card issuers to prove.

The completion of the various fields on the application form allows the cardholder to be in complete control of the up-dating of the spending pattern by defining very specific levels of use in each field or by having the ability simply to turn on or off a particular field of spending to deny, for instance, a particular financial card being used at ATMs or at a certain type of retail outlet or even a specific retail outlet. Specific levels of use may relate to geographical extent, such that a particular financial card could or could not be authorised to be used for specified fields of spending outside the United Kingdom. One important area of specific restriction relates to making use of cash-back services in retail outlets which is a popular avenue for fraudulent use of cloned or stolen financial cards, such that the ability to obtain cash-back could be prevented relatively simply and quickly with the present system. The up-dating of the database by the cardholder can limit the use of a financial card in relation to a particular field of spending to a certain time of day. For example, you may wish to limit the field of Internet spending to a few hours in the evenings only, and, thus, if the card details are fraudulently used for that field of spending outside of those few hours, the transaction would be denied.

The ability to toggle particular spending fields on or off is extremely important in certain fields of spending, such as Internet spending, in order to allow immediate switching ability to increase the security of Internet spending and to stop repeat or duplicate transactions and, of course, fraudulent use. This also applies to the other fields of spending where the transaction involves the cardholder not being present, such as spending through interactive television services or mail order spending. The fields shown in the application form in FIG. 4 are not exhaustive and could, for instance, be tailor made to a certain extent for the individual cardholder. For example, the cardholder may wish to have added a field which is headed “CHARITABLE DONATIONS” and/or a field headed “PERSONAL ATTACK WARNING SERVICE”.

The personal attack warning service operates by alerting a third party, by way of a transmitted signal created during a transaction, to the fact that the cardholder believes they are in a situation where their own security is at risk. The signal to be transmitted can be created differently depending upon the type of transaction occurring. The signal can be created at an ATM by entering an amount of money to be withdrawn which amount is entered into the database and which is an amount which would never be used in a transaction with that particular financial card, or, if the transaction is taking place in a retail outlet, the cardholder could, for example, make two consecutive purchases of the same product at the same price. The signal created during the transaction would then be transmitted to a designated third party by any convenient method, the preferred method being in the form of an SMS message. The received signal would have the effect of alerting that third party that appropriate action needs to be taken, which may involve passing the alert onto the police, a particular bank or retail store security services.

One further field that could be added by the cardholder is a direct payment option whereby non-regular payments or regular payments usually made by Direct Debit from an account can be paid using the database of the present system. As a result, such payments can be charged to a financial card rather than be debited directly from an account. The cardholder also has the advantage that he can continually up-date the database and so be in complete control of such payments.

FIG. 5 shows a form which can accompany the application form of FIG. 4 and which defines the cardholder's access to the database through use of a mobile telephone as previously described.

Different levels of security can also be built-in to the database. The more information given by a cardholder defines the level of security chosen by the cardholder, who is therefore in control of the level of security defined. If the cardholder chooses to have the highest level of security, it is possible to add to the database, electronic images of the cardholder's personal identification documents, such as passport, birth certificate, national identity card, and driving licence. Advantageously, these images have some kind for certification, such as notarisation to prove their authenticity. The electronic images would be protected by the highest level of encryption. The cardholder has the ability to pre-authorise access by third parties. Such access may be gained by the cardholder being in the presence of the third party, using for instance a specially issued card to be swiped through a card reader, or it may require the cardholder giving an operator of the database a secure code over a telecommunications link in order for the images to be accessed by the third party. Access to the relevant images could also be obtained by the third party under complete control of the cardholder using a mobile telephone.

The third party obtains access to the images on the Internet by following an authorisation procedure to establish who they are which can then be matched with the pre-authorisation given by the cardholder to the database. Only then will the third party be able to gain access to the images. Any information transmitted over the Internet to the third party will have a built-in self-destruct instruction in order to erase the information once the necessary identify verification has been carried out. The party accessing the document image is given an authorisation code by the database to tell that party that they accessed the database at a particular date and time. Since out-of-date documents cannot be held on the database (as notarisation is required) there is peace of mind for the accessing party that the document is genuine.

Advantageously, if the identity verification is also to be accompanied by a financial transaction, for instance in the hiring of a motor vehicle, then the whole transaction may take place without any physical means of identity and without any physical payment tools.

It may also be possible to travel across country borders without any physical means of identity.

For cardholders using a lower security level, the performing of any transaction with the present system can also be achievable without any physical payment tool, by choosing the aforementioned direct payment option on the application form.

The more detailed the information entered into the database through the application form by the cardholder the better the chance of preventing financial card fraud. Having the knowledge of just 20% of regular, key spending forecasts, it is believed that 80% of fraud can be prevented. The use of the present system drastically reduces the opportunities a fraudster has to commit fraud and drastically increases the chances of the fraudster being caught.

Even though, already mentioned above, the amount of protection offered by the database against fraud is directly proportional to the degree of participation and the amount of information supplied by the cardholder, even with the most basic participation, the database can aid in preventing a high proportion of fraud. For instance, for those cardholders who are unable to regularly up-date the information contained in the database, they are still able to toggle on or off the fields in the database which they feel present the highest risk.

When access is gained to the database on-line, there is a coloured alert system in operation. For example, a green indicator signals that there are no problems; an amber indicator signals that a transaction is very close or just exceeds the tolerances set to a particular forecasted transaction; and a red indicator signals that a serious breach has occurred in relation to authorised transactions. If there is an amber or a red indicator, these will flash when on-line access is gained to indicate action is required. Any transaction triggering a serious breach will, of course, be denied as it is outside any forecast in the database and therefore completely unexpected.

1-21. (canceled)

22. A security method comprising inputting into a database on a computer system data as to a forecast of transfer relative to said database, and inputting into said database data as to actual transfers relative to said database, said computer system taking appropriate action in the event that said transfers are not in accordance with said forecast.

23. A security method according to claim 22 and further comprising setting a limit on said transfers.

24. A security method according to claim 23 and further comprising setting a plus and/or minus tolerance parameter to said transfers.

25. A security method according to claim 22, wherein said taking of said appropriate action comprises communicating notification that said transfers are not in accordance with said forecast.

26. A security method according to claim 25, wherein said notification is in the form of a short message service (SMS) text to a mobile communications device.

27. A security method according to claim 22, wherein said inputting of said data as to said actual transfers comprises use of a card held by a card holder.

28. A security method according to claim 22, wherein said database, said forecast and said transfers are financial.

29. A security method according to claim 28, wherein said inputting of said data as to said actual transfers comprises use of a card held by a card holder and said data as to said forecast comprises intended future financial transactions involving use of said card by said card holder.

30. A security method according to claim 29, wherein said data as to said forecast includes identification of specific establishments where said transactions are to take place.

31. A security method according to claim 28, wherein said taking of said appropriate action comprises communicating with a financial transaction processor.

32. A security method according to claim 29, and further comprising sending to said card holder confirmation of each transaction involving said card.

33. A security method according to claim 32, wherein said confirmation is sent to said card holder electronically.

34. A security method according to claim 31, wherein said taking of said appropriate action comprises communicating notification that said transfers are not in accordance with said forecast, and said notification is communicated by said financial transaction processor to a merchant of the transaction.

35. A security method according to claim 27, wherein said taking of said appropriate action comprises communicating notification that said transfers are not in accordance with said forecast, and said computer system communicates said notification to said card holder.

36. A security method according to claim 35, and further comprising said card holder responding to said notification by up-dating said database.

37. A security method according to claim 22, and further comprising a user inputting into said database data as to a forecast of transfer relative to a predefined specific field of transfer of said database, and said user up-dating the forecasted transfer in relation to said specific field of transfer.

38. A security method according to claim 22, and further comprising performing a financial transaction, transmitting a signal as part of said transaction, and receiving said signal as a security alert.

39. A security method according to claim 22, and further comprising inputting into said database data as to a pre-authorisation of transfer relative to said database before said transfer takes place, and inputting into said database data as to an actual transfer which is said pre-authorised transfer.

40. A security method according to claim 22, and further comprising personal identification including inputting into said database identification image data of an individual, said individual allowing access to said database by an authorised other for verification of the identity of said individual.

41. Apparatus comprising a computer system for managing security, said system comprising a database and being arranged to receive data as to a forecast of transfer relative to said database and as to actual transfers relative to said database and to take appropriate action in the event that said actual transfers are not in accordance with said forecast.

42. Apparatus according to claim 41, and further comprising a card, said transfers relative to said database involving use of said card.

43. Apparatus according to claim 42, wherein said database is connected to a second computer system of a financial transaction processor and said card is a financial card.

44. Apparatus according to claim 41, and further comprising a mobile communications device of a user of said database enabling access to said database.

45. Apparatus according to claim 44, wherein the first-mentioned computer system is arranged to send and said mobile communications device is arranged to receive notification in the event that said appropriate action is being taken.

46. A computer system according to claim 44, wherein said mobile communications device can be used to up-date said database.

47. A security method comprising a user inputting into a database on a computer system data as to a forecast of transfer relative to a predefined specific field of transfer of said database, and said user up-dating the forecasted transfer in relation to said specific field of transfer.

48. A security method according to claim 47, wherein said up-dating includes turning off a particular specific field of transfer.

49. A security method according to claim 48, and further comprising preventing financial transfer in relation to said particular specific field.

50. A security method according to claim 47, wherein said up-dating comprises personalisation of said database by said user.

51. A security method comprising performing a financial transaction, transmitting a signal as part of said transaction, and receiving said signal as a security alert.

52. A security method according to claim 51, wherein said signal is in the form of an electronic signal unique to a party involved in said transaction.

53. A security method according to claim 52, wherein said signal is an SMS message.

54. A security method according to claim 51, wherein said signal is received by a third party not involved in said transaction.

55. A security method comprising inputting into a database on a computer system data as to a pre-authorisation of transfer relative to said database before said transfer takes place, and inputting into said database data as to an actual transfer which is said pre-authorised transfer.

56. A security method according to claim 55, wherein said transfer is a financial transfer.

57. A security method according to claim 56, wherein said pre-authorisation is for use of a financial card.

58. A personal identification method comprising inputting into a database on a computer system identification image data of an individual, said individual allowing access to said database by an authorised other for verification of the identity of said individual.

59. A personal identification method according to claim 58, wherein said identification image data comprises an electronic image of a personal identification document of said individual.

60. A personal identification method according to claim 58, wherein said authorised other is pre-authorised by said individual.

61. A personal identification method according to claim 58, wherein said access is gained by providing said other with a unique code of said individual.

62. A personal identification method according to claim 61, wherein said providing comprises said individual utilising a mobile communications device.

63. A personal identification method according to claim 58, wherein said access is via a web page on the Internet.

64. A personal identification method according to claim 63, and further comprising deletion of said web page once said verification has taken place.

65. A personal identification method according to claim 58, and further comprising a financial transaction.
